(19) United States
(12) Patent Application Publication
(10) Pub. No.: US 2020/0003207 A1
(43) Pub. Date: Jan. 2, 2020

(54) WATER PUMP VIBRATION DAMPING DEVICE

(71) Applicant: XIAMEN FILTERTECH INDUSTRIAL CORPORATION, Xiamen (CN)

(72) Inventors: SAN-YANG XU, Xiamen (CN); WEI-QIANG XU, Xiamen (CN); CAN-XIANG XU, Xiamen (CN)

(21) Appl. No.: 16/449,344

(22) Filed: Jun. 22, 2019

(30) Foreign Application Priority Data
Jun. 27, 2018 (CN) 201821001405.7

(51) Int. Cl. F04B 53/00; F04B 53/16

(52) U.S. Cl. CPC F04B 53/003; F05B 2260/964; F05B 2240/14; F04B 53/16

(57) ABSTRACT

A water pump vibration damping device, that includes: a water pump, a main body, a soft pad, and a connection piece. The main body is disposed for the water pump to fix thereon, and is provided with a second connection hole. The soft pad is disposed between the water pump and the main body, and on the soft pad is disposed a first connection hole acting in cooperation with the second connection hole. The connection piece is used for penetrating it through the first connection hole and the second connection hole, to fix the soft pad and the main body together.

### BACKGROUND OF THE INVENTION

### Field of the Invention

The present invention relates to a vibration damping device, and in particular to a water pump vibration damping device used on a water purifier.

### The Prior Arts

Due to the functions and characteristic of the water pump, in operation, it tends to generate quite large amount of vibrations. Since the water pump is connected and fixed on to the main body, the vibrations of the water pump could bring about the vibrations of the main body, to cause instability to its performance, while reducing its operation efficiency.

Therefore, presently, the design and performance of the water pump vibration damping device is not quite satisfactory, and it leaves much room for improvements.

### SUMMARY OF THE INVENTION

In view of the problems and drawbacks of the prior art, the present invention provides a water pump vibration damping device. A soft pad disposed between the water pump and the main body to reduce vibrations. The disposition of the soft pad is able to achieve vibration reduction effectively, thus there is no need to develop special water pump rack, while reducing production cost.

The present invention provides a water pump vibration damping device, that comprises: a water pump; a main body, a soft pad, and a connection piece. Wherein, for the main body, the water pump is fixed onto the main body, and is provided with a second connection hole. The soft pad is disposed between the water pump and the main body, and on the soft pad is disposed a first connection hole acting in cooperation with the second connection hole. For the connection piece, the soft pad and the main body are fixed together by the connection piece penetrating through the first connection hole and the second connection hole.

In an aspect of the present invention, on an end face of the soft pad is provided with a plurality of ribs, the end face of the soft pad having the plurality of ribs is in contact with the water pump.

In another aspect of the present invention, the plurality of ribs are distributed and spaced apart evenly on the end face of the soft pad.

In yet another aspect of the present invention, a plurality of position points are disposed on the other end face of the soft pad, and a plurality of restriction grooves are disposed on the main body to act in cooperation with the plurality of position points.

In a further aspect of the present invention, the plurality of position points are disposed into a rectangular array on the other end face of the soft pad.

In an aspect of the present invention, the total number of the position points is four.

In another aspect of the present invention, a hollow portion is provided on the soft pad.

In yet another aspect of the present invention, on a protrusion is disposed the first connection hole.

In a further aspect of the present invention, the total number of the first connection holes is two.

In another aspect of the present invention, on the first connection holes are provided with inner threads, and the connection piece is a screw.

Compared with the Prior Art, the present invention has the following advantages:

1. Soft pad is used to realize vibration damping, to save material cost, and reduce production cost.

2. Ribs are disposed on the soft pad, such that the water pump is able to move slightly in the space enclosed by the soft pad, to achieve better vibration damping.

3. Position points are disposed on the soft pad, to raise the efficiency of installing the soft pad with the main body and the water pump, to achieve more accurate positioning.

4. Hollow portion is disposed on the soft pad, to reduce effectively the weight of the soft pad, while raising heat dissipation efficiency of the water pump.

5. Screws are used to fix the soft pad and the main body, to enhance fixing stability.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from the detailed descriptions.

### BRIEF DESCRIPTION OF THE DRAWINGS

The related drawings in connection with the detailed descriptions of the present invention to be made later are described briefly as follows, in which:

FIG. 1 is a first schematic diagram of a water pump vibration damping device according to the present invention;

FIG. 2 is a second schematic diagram of a water pump vibration damping device according to the present invention;

FIG. 3 is a third schematic diagram of a water pump vibration damping device according to the present invention;

FIG. 4 is a fourth schematic diagram of a water pump vibration damping device according to the present invention;

FIG. 5 is a first schematic diagram of a soft pad and a water pump in assembly according to the present invention;

FIG. 6 is a second schematic diagram of a soft pad and a water pump in assembly according to the present invention; and

FIG. 7 is a schematic diagram of a soft pad according to the present invention.

### DETAILED DESCRIPTION OF THE PREFERRED EMBODIMENT

The purpose, construction, features, functions and advantages of the present invention can be appreciated and understood more thoroughly through the following detailed descriptions with reference to the attached drawings.

In the following, an embodiment is used to describe the various details of the present invention. However, it does not mean that this embodiment represents all the embodiments of the present invention. Other embodiments can be envisaged by people familiar with this field, and thus they all fall into the scope of the present invention.

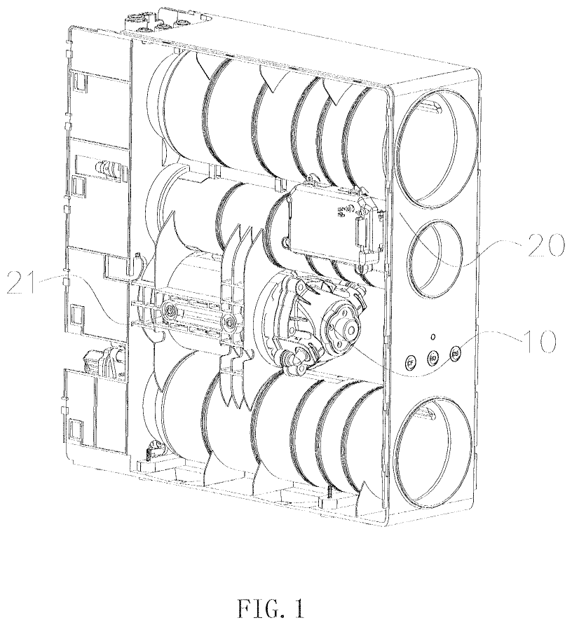

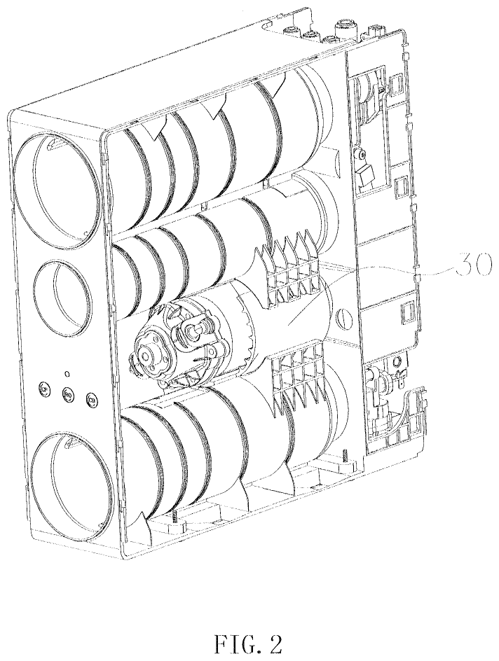

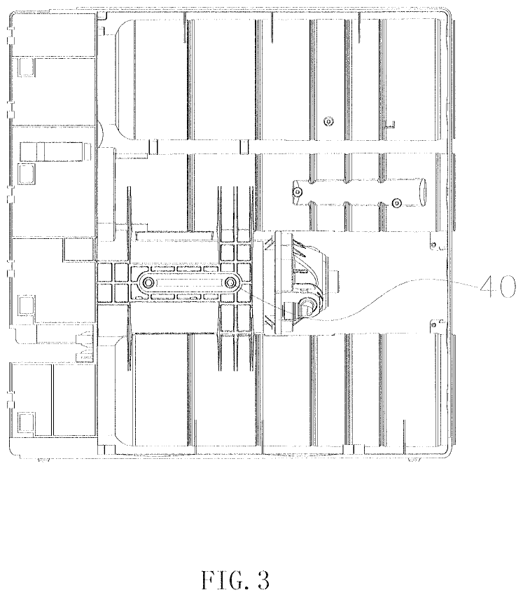

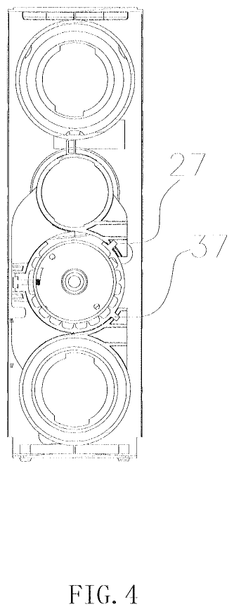

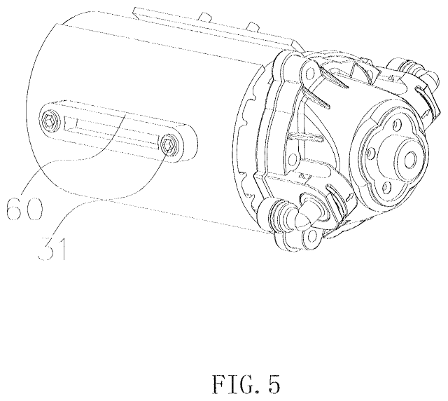

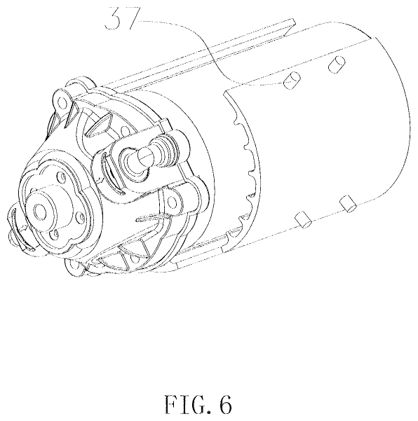

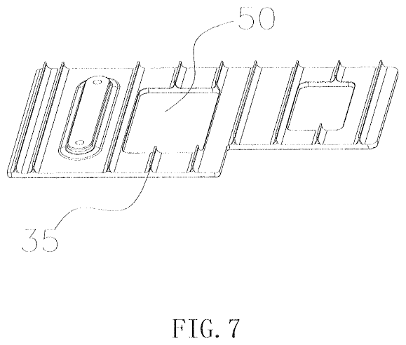

Refer to FIGS. 1 to 7 for a first schematic diagram of a water pump vibration damping device according to the present invention; a second schematic diagram of a water pump vibration damping device according to the present invention; a third schematic diagram of a water pump vibration damping device according to the present invention; a fourth schematic diagram of a water pump vibration damping device according to the present invention; a first schematic diagram of a soft pad and a water pump in assembly according to the present invention; a second schematic diagram of a soft pad and a water pump in assembly according to the present invention; and a schematic diagram of a soft pad according to the present invention.

As shown in FIGS. 1 to 7, the present invention provides a water pump vibration damping device, that includes: a water pump 10; a main body 20, a soft pad 30, and a connection piece 40. Wherein, the water pump 10 is fixed onto the main body 20, and is provided with a second connection hole 21. The soft pad 30 is disposed between the water pump 10 and the main body 20, and on the soft pad 30 is disposed a first connection hole 31 acting in cooperation with the second connection hole 21 disposed on the main body 20. For the connection piece 40, the soft pad 30 and the main body 20 are fixed together by the connection piece 40 penetrating through the first connection hole 31 and the second connection hole 21. Due to the disposition of the soft pad 30, in operation, the vibrations of the water pump 10 can be reduced significantly, to raise operation stability while reducing noises.

On an end face of the soft pad 30 is provided with a plurality of ribs 35, the end face of the soft pad 30 having the plurality of ribs 35 is in contact with the water pump 10. The plurality of ribs 35 are distributed and spaced apart evenly on the end face of the soft pad 30. Due to the disposition of the ribs 35 on the soft pad 30, the water pump 10 may move slightly in the space enclosed by the soft pad 30, to achieve better vibration damping for the water pump 10.

A plurality of position points 37 are disposed on the other end face of the soft pad 30, and a plurality of restriction grooves 27 are disposed on the main body 20 to act in cooperation with the plurality of position points 37. Due to the disposition of the position points 37 and the restriction grooves 27, it is able to facilitate and expediate installation, raise operation efficiency of the water pump, while increasing the installation precision of the water pump 10, and ensuring operation stability of the water pump 10.

In an embodiment of the present invention four position points 37 are disposed into a rectangular array on the other end face of the soft pad 30. Due to the disposition of 4 position points 37, it is able to restrict and position the soft pad 30 and the main body 20, to achieve precise cooperation, and to prevent shifting of the soft pad 30.

A hollow portion 50 is disposed on the soft pad 30, to reduce weight of the soft pad 30 and the production cost, thus ensuring effective vibration damping of the soft pad 30 and better heat dissipation for the water pump 10.

The first connection hole 31 is disposed on a protrusion 60, and the protrusion 60 and the soft pad 30 are formed into a body. The disposition of the protrusion 60 facilitate connection of the soft pad 30 with the main body 20.

In an embodiment of the present invention, two first connection holes 31 are provided. The disposition of the two first connection holes 31 enables fixed and stable connection of the soft pad 30 and the main body 20.

On the first connection hole 31 is disposed inner threads, and the connection piece 40 is a screw. The disposition of screw as the connection piece 40 is able to provide sufficient strength to reduce vibrations of the water pump 10.

During installation, firstly connecting the soft pad 30 to the main body 20. Since the restriction grooves 27 are disposed on the main body 20, therefore in the positioning process, all it needs to do is to align the position points 37 on the soft pad 30 with the restriction grooves 27, and insert the former into the latter. Then, place the soft pad 30 evenly on the main body 20, to align the first connection holes 31 on the soft pad 30 with the second connection hole 21 on the main body 20. After alignment, put the connection piece 40 through the first connection 31 and the second connection hole 21, to fix and lock the soft pad 30 with the main body 20 tightly. Finally, place the water pump 10 on the soft pad 30.

In operation, the water pump 10 is certain to produce vibrations. Due to vibrations of the water pump 10, the ribs 35 on the soft pad 30 tend to produce a yielding effect. Since the soft pad 30 is elastic, the vibration of the water pump 10 could produce oscillations, to cause the ribs 35 to move back and forth in a certain extent, to buffer the vibrations of the water pump 10, while reducing the vibrations of the water pump 10, and raising its operation stability.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A water pump vibration damping device, comprising:
a water pump;
a main body, the water pump is fixed onto the main body, and is provided with a second connection hole;
a soft pad, disposed between the water pump and the main body, and on the soft pad is disposed a first connection hole acting in cooperation with the second connection hole; and
a connection piece, the soft pad and the main body are fixed together by the connection piece penetrating through the first connection hole and the second connection hole.

2. The water pump vibration damping device as claimed in claim 1, wherein on an end face of the soft pad is provided with a plurality of ribs, the end face of the soft pad having the plurality of ribs is in contact with the water pump.

3. The water pump vibration damping device as claimed in claim 2, wherein the plurality of ribs are distributed and spaced apart on the end face of the soft pad.

4. The water pump vibration damping device as claimed in claim 3, wherein a plurality of position points are disposed on the other end face of the soft pad, and a plurality of restriction grooves are disposed on the main body to act in cooperation with the plurality of position points.

5. The water pump vibration damping device as claimed in claim 4, wherein the plurality of position points are disposed into a rectangular array on the other end face of the soft pad.

6. The water pump vibration damping device as claimed in claim 5, wherein a total number of the position points is four.

7. The water pump vibration damping device as claimed in claim 1, wherein a hollow portion is provided on the soft pad.

8. The water pump vibration damping device as claimed in claim 1, wherein on a protrusion is disposed the first connection hole.

9. The water pump vibration damping device as claimed in claim 1, wherein a total number of the first connection holes is two.

10. The water pump vibration damping device as claimed in claim 1, wherein on the first connection holes are provided with inner threads, and the connection piece is a screw.
